(19) United States
(12) Patent Application Publication
(10) Pub. No.: US 2020/0023769 A1
(43) Pub. Date: Jan. 23, 2020

(54) Enhanced Vehicle Safety System

(71) Applicant: Yong Guk Yi, Corona, CA (US)

(72) Inventor: Yong Guk Yi, Corona, CA (US)

(21) Appl. No.: 15/958,335

(22) Filed: Apr. 20, 2018

(51) Int. Cl. B60Q 1/44; B60Q 1/26; B60Q 1/04; B60Q 5/00; G08G 1/16

(52) U.S. Cl. CPC B60Q 1/44; B60Q 1/268; G08G 1/166; B60Q 5/006; B60Q 1/04

(57) ABSTRACT

A system to enhance vehicle safety, comprising a vehicle having at least one visual signal light positioned in the proximity to said front end of the vehicle; where the visual signal light illuminates when said vehicle's is decelerating via its braking system where the visual signal light is comprised of a power source and a wireless connection module wherein said visual signal light is controlled by the vehicle via its wireless connection module and an audio module that is activated by the vehicle when the vehicle is decelerating via its braking system.

### FIELD OF INVENTION

The present invention relates generally to vehicle safety features, and more specifically to a forward facing brake light indicator.

### BACKGROUND

Recent years have seen the incorporation of a variety of automated safety features incorporated into vehicles. Nearly all of these safety features are focused on the safety and protection of the vehicles passengers. While recent years have brought airbags, proximity sensors, and cameras to the market, currently existing technology, namely warning lights, has been stagnant in comparison. Notably communication of a driver's intentions to those around them seems to be still completely forgotten or ignored by vehicle manufactures.

While it has become conventional and mandatory for vehicles to be sold with preinstalled tail-lights which indicate to those behind the vehicle the intentions of the driver, the information as to the whether or not the brake is engaged is not information that is communicated to those in front of the vehicle.

Any driver can attest that despite the teachings of driving school, navigating amongst pedestrians in a parking lot or determining who was first to an unsignaled intersection has led to many near collisions. Worse still, is this lack of communication has undoubtedly resulted in actual collision and unfortunately injury and death.

Defensive driving and predicting another party's intentions, while valuable to any driver, can still be augmented and enhanced with additional information.

It is clear that it is both valuable and necessary for a driver to be able to indicate those in front of his or her vehicle that the brake is engaged, and that the vehicle is at a complete stop. Enabling such a system would eliminate many accidents and the uncertainty that pedestrians face in parking lots and cross walks.

Further, such a system could easily facilitate other improvements such as auditory warnings as well as visual indicators. This is beneficial as it increases safety even further, but also provides additional alert capabilities to those that may be unable to see the visual indicators.

Today's driver is often distracted by technology or otherwise, or bombarded with information from their vehicle. Such a system can factor in the precision of the proximity, distance, location, and CPU information that a vehicle is calculating in real-time, and in the event of driver failure, self-activate and attempt to warn those in the vicinity of the vehicle.

Such a system is now no longer out of reach of economic feasibility to create and implement in new vehicles, and as an aftermarket addition to vehicles that are already in service. Further, the state of the current technology would allow for such a system to be installed potentially with minimal intrusion. With wireless connectivity now common, inexpensive, and increasingly dependable, a user of the contemplated invention would be able to install it with minimal effort. Further, such a system could become a hub of sorts, whereby a user might be able to configure and customize the features of the system wirelessly.

Finally, while modern cars are commonly integrating onboard CPUs, and a variety of sensors, many of these sensors are inaccessible and closed off to the typical user. It is an object of this invention to allow a user to access these capabilities in yet a new way, enabling additional safety features to parking maneuvers as well as driving.

### OBJECTIVE OF THE INVENTION

It is an object of this invention to provide a forward facing brake light which is directed by a master brake control system such that it can be easily communicated to those in the front of a vehicle that the brakes are engaged.

It is an additional object of this invention to enable a master brake control system such that in addition to the driver's manual input, gps, cpu, Bluetooth, and proximity, distance, and other similar sensors may provide valuable input such that the front facing brake lights may be activated when context dictates it is appropriate to do so.

Is if further an object of this invention to allow for the master brake control system the ability to communicate audible warnings utilizing either the vehicles factory installed horn or an aftermarket speaker.

It is an additional object of this invention to make it wireless and easy to install such that unexperienced consumers will feel comfortable installing the device as mass adoption means safer roads for all. Further, wireless installation would allow for vehicles currently in service to be retrofitted with the invention with ease and speed.

It is further an object to provide a brake light indicator assembly which may be externally powered independent of the vehicles power supply but may operate as an auxiliary battery if so connected and enabled.

It is further an object to provide a brake light indicator assembly which conforms to current materials and manufacturing thresholds that the automobile industry self imposes and that the United States DOT demands.

It is further an object of this invention to provide to the driver valuable visual feedback when attempting difficult parking maneuvers and provide a visual parking assistance warning. A system to enhance vehicle safety is disclosed, comprising a vehicle having a front end and a rear end; at least one visual signal light positioned in the proximity to the front end of the vehicle; and visual signal light illuminates when the vehicle's is decelerating via its braking system. In one embodiment, the visual signal light is comprised of a power source and a wireless connection module wherein the visual signal light is controlled by the vehicle via the wireless connection module.

In one embodiment, the vehicle is comprised of a central processing unit capable of controlling vehicle functions. In one embodiment, the visual signal light is comprised of a power source and a wireless connection module wherein the visual signal light is controlled by a smartphone via the wireless connection module. In one embodiment, the smartphone is comprised of a central processing unit and a phone application that controls the vehicle's functions. In one embodiment, the phone application receives telemetric from the vehicle and controls the visual signal light based on the received telemetric. In one embodiment, the visual signal light's power source is a battery powered source. In one embodiment, the visual signal light's power source is a solar powered source.

In one embodiment, the visual signal light's power source is a provided by the vehicle's power system. In one embodiment, the visual signal light's power source is a battery powered source. In one embodiment, the visual signal lights power source is a solar powered source. In one embodiment, the visual signal light's power source is a provided by the vehicle's power system. In one embodiment, the system further comprising an audio module wherein the audio signal activates when the vehicle is decelerating via the braking system. In one embodiment, the system further comprising a motion sensor and an audio module wherein the audio signal activates when the motion sensor detects approaching objects. In one embodiment, the approaching objects is a pedestrian. In one embodiment, the approaching objects is a vehicle. In one embodiment, the visual signal light illuminates when the motion sensor detects approaching objects. In one embodiment, the vehicle is comprised of a pair of headlights and the visual signal light is located with the vehicle's headlight. In one embodiment, the vehicle is comprised of a pair of headlights and the visual signal light is located with the vehicle's headlight. In one embodiment, the vehicle is comprised of a front bumper and the visual signal light is located on the front bumper.

In one embodiment, the vehicle is comprised of a grille and the visual signal light is attached to the grille. In one embodiment, the vehicle is comprised of a front windshield and the visual signal light is mounted on the front windshield. In one embodiment, the vehicle is comprised of a front windshield and the visual signal light is mounted on the front windshield. In one embodiment, the vehicle's central processing unit receives telemetric from the vehicle and controls the visual signal light based on the received telemetric.

### BRIEF DESCRIPTION

The present invention will be understood and appreciated more fully from the following detailed description taken in conjunction with the drawings in which:

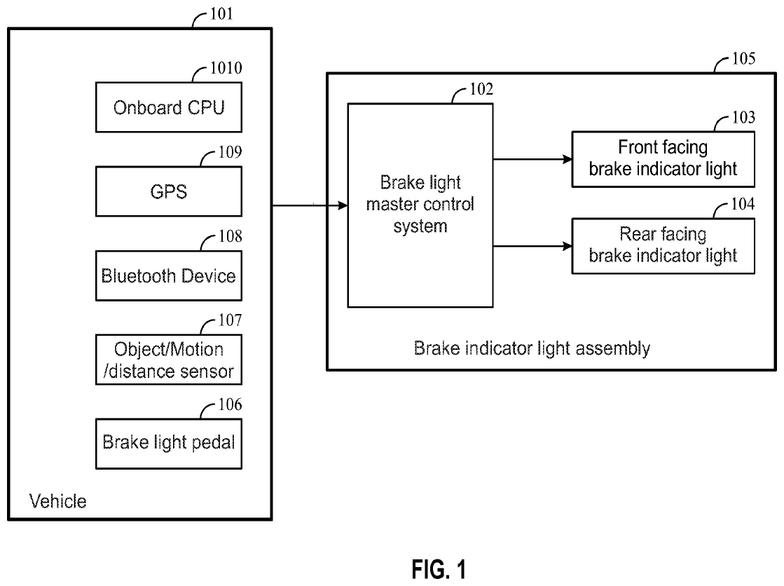

FIG. 1 is a system diagram illustrating the present invention wherein the diagram discloses the apparatus of the present invention comprising a brake light master control system and a front facing brake indicator light.

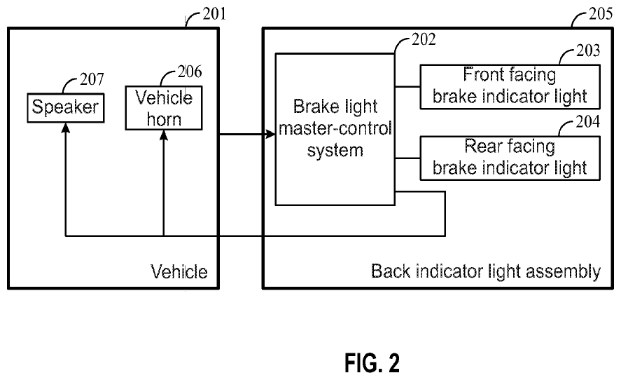

FIG. 2 is a system diagram of FIG. 1. where the brake indicator light assembly further includes the addition of a speaker or other audio device or the capability to interact with the vehicle's factory installed horn.

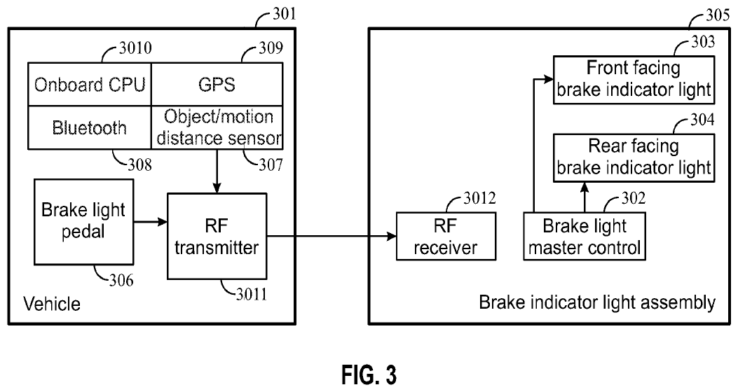

FIG. 3 is a system diagram of FIG. 1. where the brake indicator light assembly further includes the addition of a RC receiver and the addition of a RF transmitter to enable wireless installation and functionality.

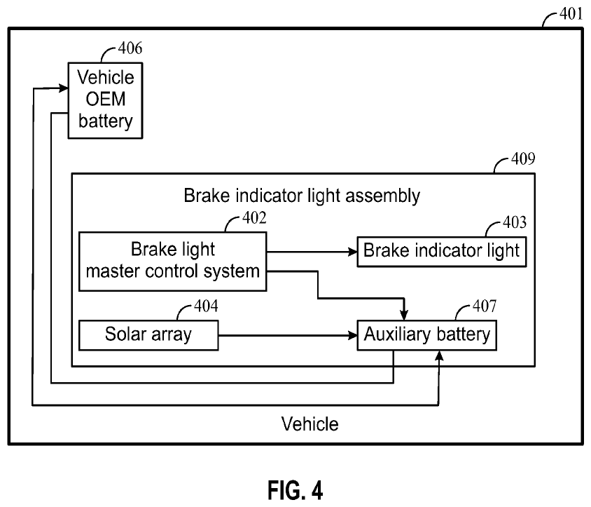

FIG. 4 is a system diagram of FIG. 1. where the brake indicator light assembly further includes the addition of a solar array and an auxiliary battery that may function either independently or in serial with the vehicle's factory installed battery.

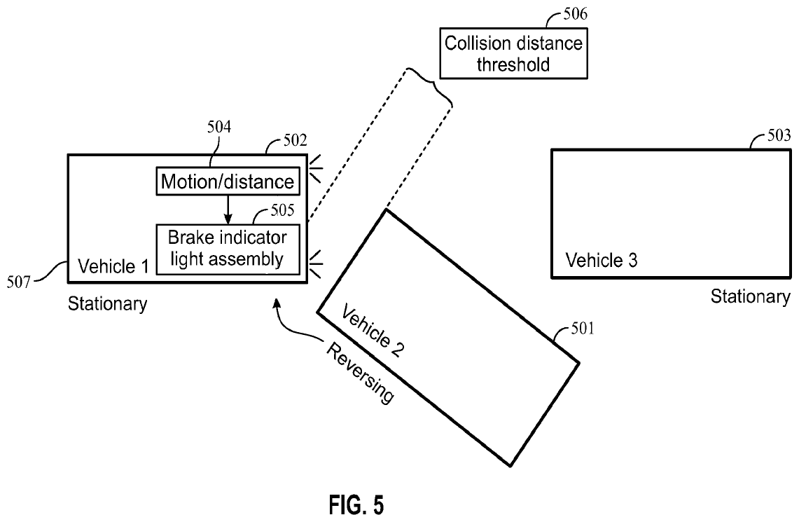

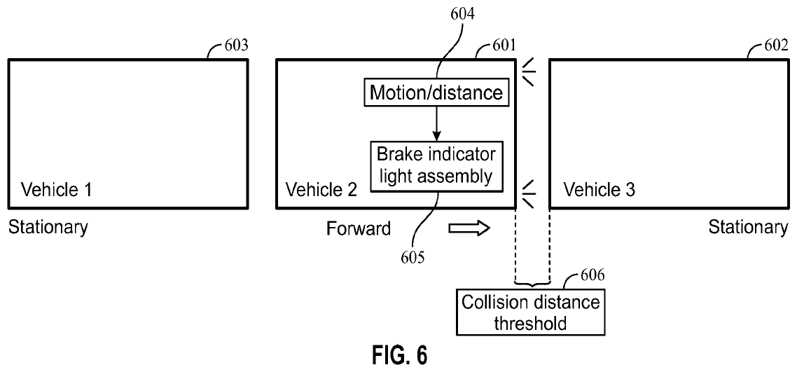

FIG. 5 and FIG. 6 are pictorial illustrations of the present invention enabling additional parking assistance functionality.

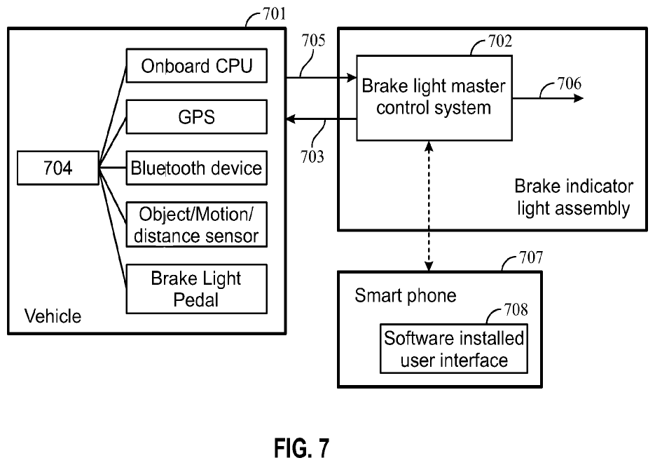

FIG. 7 is a system diagram of FIG. 1. where the brake indicator light assembly further includes the addition of external smart phone connectivity whereby by way of a software interface on the user's smart phone, a user may interact directly with the brake light master control system and control the respective settings for the described system. In turn, the brake light master control system, in a preferred embodiment would also be able to interact with the onboard car GPS as well as the other electronic sensors and systems to allow further tuning and customization.

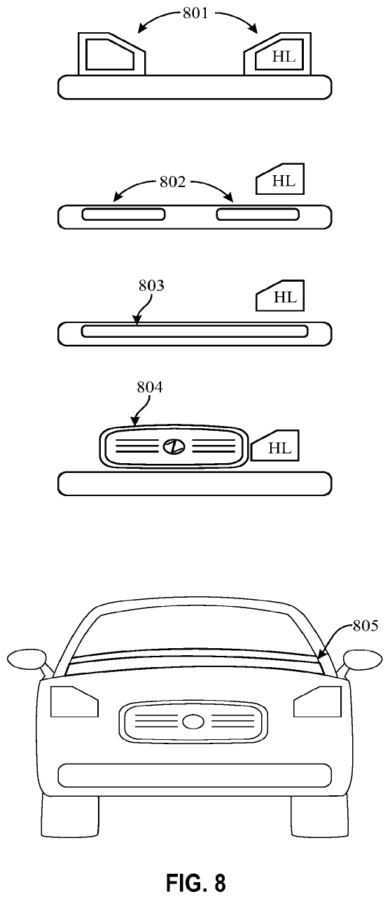

FIG. 8 is a pictorial illustration of contemplated positioning of the front facing brake indicator light in accordance with an embodiment of the present invention.

### DETAILED DESCRIPTION

Reference is now made to FIG. 1, which illustrates an apparatus comprising a brake indicator light assembly 105, constructed and operative in accordance with an embodiment of the present invention.

In FIG. 1, the diagram discloses a typical embodiment on the present invention. The apparatus comprises a braking indicator light assembly 105 which includes at least a front facing brake indicator light 103 which is coupled to a brake light master control system 102 which is connected to the vehicles electrical system and mechanically connected to the vehicle 101. Disclosed also is a brake light master control system 102 which responsible for powering and turning on and off both the front face brake indicator light 103 and the rear facing brake indicator light 104. Also disclosed in the diagram is a brake light pedal 106, which when depressed, sends a signal to the brake light master control 102 which responds by powering and turning on and off both the front facing brake indicator light 103 and the rear facing indicator light 104 according to the rules governing the brake light master control system's 102 output to each of these respective lights.

The brake light master control system 102 itself receives input from the brake light pedal 106, but it is also contemplated that input may be received directly from the vehicle cpu 1010, vehicle attached GPS 109, Bluetooth paired GPS 108, object recognition sensors 107, motion sensors 107, or collision detection systems 107 such that if it is anticipated that the vehicle may be coming to a stop, the brake light master control system 102 interacts with and activates the front facing brake indicator light 103 and rear facing brake indicator light 104 regardless of any input from the brake light pedal 106.

In an exemplary embodiment of the invention, both the brake light master control 102 and the front facing brake indicator light 103 are accommodated for and incorporated into the vehicle's design and original assembly. However, it should be understood that it is contemplated that the brake light master control 102 and front facing brake indicator light 103 may, in the alternate, be wired into and attached to the vehicle after factory assembly has occurred. In one embodiment this is accomplished by way of the brake light master control 102 being wired in series in the factory connection that would electrically connect the brake light pedal 106 with the rear facing brake indicator light. In yet another embodiment, the brake indicator light assembly 105 is attached to the vehicle 101 without a modification to the factory assembled wiring and operates as a system without sending output to the vehicle's rear facing brake indicator light 104. In a post-factory embodiment, the front facing brake indicator light 103 itself would necessitate mechanical attachment to fixed front facing position of the vehicle.

In an exemplary embodiment of the invention, the brake light master control 102 sends identical signals to both the front and rear facing brake indicator lights 103 104 as to whether or not to light or not. However, it is contemplated that it may be desirable for the front facing brake indicator light 103 to blink, flash, or send other visual cues or warnings. As such, the brake light master control 102 may also receive input from the brake pedal 106 and other sources and sensors mentioned above and instead operate the front facing brake indicator light 103 and the rear facing brake indicator light 104 such that the state of each light does not necessarily match each other at all times.

Now referring to FIG. 2, the diagram discloses essentially the same system as disclosed in FIG. 1 installed onto a vehicle 201 except that the brake indicator light assembly 205 now contemplates a brake light master control system 202 that in addition to controlling the output to the front and rear facing brake indicator lights 203 204 now also has an the capability to send output to the vehicle's factory installed horn 206, thus enabling the invention the capability of providing an audio alert. It would not be desirable for the horn to activate each time the vehicle's brakes were engaged. However, in conjunction with the other computer driven input as discussed above, it would be desirable for the brake light master control system 202 to engage the horn 206 when it has been detected that either a collision with another detected object may be imminent or merely because it has been detected that the vehicle has either rapidly decelerated or came to a sudden stop.

This additional auditory feature would serve to increase the inventions primary purpose, which is communication to other vehicles and pedestrians, and as such, increased safety for all those that share the road.

In yet another embodiment, the addition of a speaker 207 is considered. With the addition of a speaker 207, the brake master control would be able to communicate separate or in addition to the vehicle's horn 206. Traffic safety studies may yet determine that it is preferable that the vehicle's horn be reserved its distinctive tone, and that for the purposes of indicating a vehicle is at rest, another tone be assigned, much in the way the public is now familiar with the distinctive tones that have become associated with large vehicles moving in reverse.

Further, it has now become common in larger cities to encounter crosswalks that provide distinctive auditory signals that those with blindness or vision disabilities are familiar with. In the same way, the present invention would be enabled by means of the above discussed GPS or sensors to detect that the vehicle is stopped at a crosswalk, and similarly indicate these same distinctive “chirps” or audio cues to pedestrians that it is safe to walk in front of the vehicle.

Now referring to FIG. 3, the diagram discloses essentially the same system as disclosed in FIG. 1. installed onto a vehicle 301 except that in lieu of the brake light pedal 306 communicating to the brake light master control system 302 by way of a direct electrical connection, communication is now accomplished by way of the addition of a RF transmitter 3011 and a RF receiver 3012. The brake light master control system 302 would continue to function as described above and control the output to the front and rear facing brake indicator lights 303 304. Braking input would be received by the RF transmitter 3011 by way of the brake light pedal 306, vehicle cpu 3010, vehicle attached GPS 309, Bluetooth paired GPS 308, object recognition sensors 307, motion sensors 307, or collision detection systems 307 and then relayed to the RF receiver 3012, which would interact directly with the brake light master control system 302.

While the exemplary embodiment of the invention prefers a design whereby the brake light indicator assembly 305 is directly incorporated into the design and factory installed, it must be considered that it is still desirable to accommodate a quick, simple and un-intrusive installation of the brake light indicator assembly 305.

It must be considered that factory installed safety improvements do nothing to improve the safety of the drivers who do not plan on purchasing a new vehicle in the near future.

As such, it is desirable to enable the invention to be retro-fitted to vehicles that are already manufactured and on the road in a manner such that a consumer may purchase the device and self-install with as little difficulty as possible. Because the electrical systems of vehicles are likely to be the most obvious bottleneck for the installation of an electrically powered aftermarket device, the easiest way to simplify the aftermarket device is to eliminate features of the device that could be directly wired and instead substitute wireless interactivity. A comparable analogy would be aftermarket car alarms, many of which began to simplify the amount of wiring and installation required in order to appeal to consumers that were unwilling or financially unable to pursue professional installation services.

Further, it must also be considered that classic or antique cars electrical systems may be unable to accommodate the present invention such that the contemplated wireless connectivity must be utilized.

Now referring to FIG. 4, the diagram discloses essentially the same system as disclosed in FIG. 1. except that the brake indicator light assembly 405, which includes both the brake light master control system 402 and brake indicator light(s) 403 would additionally now includes a power supply in the form of an auxiliary battery 407 which is separate and distinct from the vehicle's factory installed battery 406, as well as a solar array 404 to facilitate charging this separate battery.

As was similarly contemplated in the discussion of FIG. 3 above, the elimination of professional installation or invasive installation is desirable.

As such, it may be preferable to have the disclosed invention be powered by a battery that is independent of the vehicle's factory installed battery.

This configuration would allow for the invention, in combination with the RF technology disclosed above, to be reduced to distinct physical components that would merely require mechanical attachment by the aftermarket consumer.

However, it may also be desirable to instead wire this auxiliary battery 407 and solar array 404, such that the installation of the brake indicator light assembly 405 to any vehicle would enable a source of emergency power, such that the vehicle could either start from the auxiliary battery 407 in the event of the vehicles main battery 406 failure. Should the output of this auxiliary battery 407 be insufficient to jump start an automobile, it may still operate such that in emergency conditions it would be able to charge small electronics.

This additional functionality would further incentivize vehicle manufacturers and aftermarket adoption.

Now referring to FIG. 5, the illustration discloses additional functionality of the invention. In particular, it is desirable for motorists who are attempting difficult parking maneuvers to receive warnings in order to avoid collision.

While it is now becoming more commonplace for vehicles to come installed with cameras and/or proximity detectors that sound to facilitate parking, in another embodiment of the invention it is disclosed a method for indicating to drivers a visual indicator that collision is imminent.

In FIG. 5., a parking vehicle 501 is contemplated wherein the driver is attempting to reverse into a parking spot and parallel park between two vehicles 503 507. The disclosed invention is installed 502 on parked vehicle 507. As parking vehicle 501 begins to reverse into the parking spot, parked vehicle 502's motion and/or distance sensors 504 become active. Once parking vehicle 501 is within sufficient distance such that it has crosses a collision distance threshold 506, the motion and/or distance sensors 504 interact with the brake indicator light assembly 505 such that the brake light master control activates the front facing brake indicator light, alerting the parking vehicle 501 that it is too close and needs to stop.

Similarly in FIG. 6., the parking vehicle 601 is now outfitted with the disclosed invention 605 and attempting parking between vehicles 603 602. As in FIG. 5., the same system would indicate to the driver that their vehicle is now dangerously close to colliding with the car directly to the vehicle's front, parked vehicle 602, once the motion and/or distance sensors 604 detected the collision distance threshold 606 had been crossed and collision was imminent.

Now referring to FIG. 7, the diagram discloses essentially the same system as disclosed in FIG. 1. except that the brake indicator light assembly attached to a vehicle 701, which includes the brake light master control system 702 would now additionally include the capability to communicate wirelessly with a user's smartphone 707 by way of a software installed user interface 708 on said phone.

In such an embodiment, it is contemplated, and has been discussed above, that it is likely preferable to minimize the amount of aftermarket wiring that the installation of such a system might require. Further, as has been contemplated and discussed above, the brake light master control system is likely to be receiving input 705 from a multitude of sources, including but not limited to a brake light pedal, the vehicle's onboard gps, a gps system, Bluetooth enabled devices, and a variety of object, motion and distance sensors 704. As such, it is preferable to instead consider the brake light master control system 702 the central hub for all of these received signals and configure the responses of the system directly with the brake light master control system instead of each of these different input sources 704 individually.

It is further considered that the optimal installation point of the brake light master control system 702 may be in a corner of the engine compartment, the trunk, under a seat, or in another location such that the vehicles overall aesthetic is left unchanged. As such, instead of communicating these setting by way of direct physical interaction the brake light master control system 702, instead the user only needs to tune and modify the settings of the system by way of their smart phone 702 and the software 708 installed thereupon.

A user would by way of such an interface would be able to not only tune the output 706 that the brake light master control system would send to the vehicle's braking light but in another contemplated embodiment, use this interface to make configurations upstream 703 to the various input sources 704 as well. Such an embodiment would be preferable as it is both practical and desirable for a user to have access to one interface that controls and configures a multitude of systems as opposed to interacting with each system and device separately when tuning and customizing for their particular purposes.

Finally, FIG. 8, illustrates a multitude of contemplated positions for the front facing brake indicator light.

It may be desirable to allow for multiple configurations as studies may show that pedestrians are particularly receptive to one configuration over another. Further, vehicle manufacturers may also want to maintain or present a particular aesthetic style with their line of vehicles.

As contemplated, these additional lights might be places around the current headlight housings 801, in line with the bumper either as a single bar of warning light 803 or broken into multiple lights across the front bumper 802, or incorporated into and around the vehicles front grill and emblem 804. Finally, in an effort to further distinguish the brake light from the current traditionally placed lights on a vehicle, it is contemplated that the light(s) might be placed along the bottom of the windshield 805.

In an exemplary embodiment, the light utilized LED or similar technology such that the front facing brake indicator light is bright enough to be recognized for purposes of both traffic standards and readability and recognition of pedestrians and other non-motorized vehicle traffic. Further, LED or similar technology has been shown to be a durable light source that can last for more light hours than standard filament based light bulbs. Further, LED or similar technology would allow auto manufactures the most convenience and freedom into incorporating into auto body styles as LED or similar technology requires less physical area to occupy. However, it should be understood that traditional vehicle light bulb technology is contemplated, and in the alternative, employed as a substitute.

1. A system to enhance vehicle safety, comprising
a. A vehicle having a front end, a rear end, a grille that comprises a trim, and an emblem;
b. At least one visual signal light disposed along said trim;
c. Said visual signal light illuminates when said vehicle's is decelerating via its braking system,
wherein said visual signal light is installed into and around said grille;
wherein said visual signal light is installed into and around said emblem.

2. The system of claim 1 wherein said visual signal light is comprised of a power source and a wireless connection module wherein said visual signal light is controlled by said vehicle via said wireless connection module.

3. The system of claim 1 wherein said vehicle is comprised of a central processing unit that controls vehicle functions.

4. The system of claim 1 wherein said visual signal light is comprised of a power source and a wireless connection module wherein said visual signal light is controlled by a smartphone via said wireless connection module.

5. The system of claim 4 wherein said smartphone is comprised of a central processing unit and a phone application that controls said vehicle's functions.

6. The system of claim 5 wherein said phone application receives telemetric from said vehicle and controls said visual signal light based on said received telemetric.

7. The system of claim 2 wherein said visual signal light's power source is a battery powered source.

8. The system of claim 2 wherein said visual signal light's power source is a solar powered source.

9. The system of claim 2 wherein said visual signal light's powered source is a provided by said vehicle's power system.

10. The system of claim 4 wherein said visual signal light's powered source is a battery powered source.

11. The system of claim 4 wherein said visual signal light's power source is a solar powered source.

12. The system of claim 4 wherein said visual signal light's power source is a provided by said vehicle's power system.

13. The system of claim 1 further comprising an audio module wherein said audio signal activates when said vehicle is decelerating via said braking system.

14. The system of claim 1 further comprising a motion sensor and an audio module that activates when said motion sensor detects approaching objects.

15. The system of claim 14 wherein said approaching objects is a pedestrian

16. The system of claim 14 wherein said approaching objects is a vehicle.

17. The system of claim 14 wherein said visual signal light illuminates when said motion sensor detects approaching objects.

18. The system of claim 1 wherein said vehicle is comprised of a pair of headlights and said visual signal light is located with said vehicle's headlight.

19. (canceled)

20. The system of claim 1 wherein said vehicle is comprised of a front bumper and said visual signal light is located on said front bumper.

21. (canceled)

22. The system of claim 1 wherein said vehicle is comprised of a front windshield and said visual signal light is elongated and mounted across said front windshield.

23. (canceled)

24. The system of claim 3 wherein said vehicle's central processing unit receives telemetric from said vehicle and controls said visual signal light based on said received telemetric.
